(19) United States
(12) Patent Application Publication
(10) Pub. No.: US 2026/0194044 A1
(43) Pub. Date: Jul. 9, 2026

(54) WIND TURBINE FAULT DIAGNOSIS METHOD AND SYSTEM BASED ON SVD-SSA-LSTM

(71) Applicant: HUANENG ANHUI HUAINING WIND POWER GENERATION CO., LTD., Anqing (CN)

(72) Inventors: CHAO WANG, Anqing (CN); LIANBO LIU, Anqing (CN); RENWEI LUO, Anqing (CN); WENHUA DAI, Anqing (CN); HAIWANG LIU, Anqing (CN); XIN ZENG, Anqing (CN); WEI YANG, Anqing (CN); CHAO XIONG, Anqing (CN)

(73) Assignee: HUANENG ANHUI HUAINING WIND POWER GENERATION CO., LTD., Anqing (CN)

(21) Appl. No.: 19/346,446

(22) Filed: Sep. 30, 2025

(30) Foreign Application Priority Data
Jan. 6, 2025 (CN) 202510016960.5

(51) Int. Cl. F03D 17/00

(52) U.S. Cl. CPC F03D 17/014; F03D 17/0065; F03D 17/015; F05B 2260/84; F05B 2270/334

(57) ABSTRACT

Provided are a wind turbine fault diagnosis method and system based on SVD-SSA-LSTM. The method includes: setting a plurality of monitoring points according to equipment parameters of a wind turbine tower; acquiring vibration signals of each monitoring point according to preset monitoring time nodes, and generating a fault feature data packet according to all the vibration signals; and establishing a fault diagnosis model, and generating a fault diagnosis result according to the fault diagnosis model and the fault feature data packet. The collected vibration signals are decomposed by using singular value decomposition (SVD) noise reduction to remove redundant and noise components therein, then faults of the wind turbine is diagnosed by using a SSA-LSTM fault diagnosis model, and through the capability of a LSTM network to process time-series data, the accuracy of fault diagnosis is improved, while the diagnosis cycle is shorten and the early warning efficiency is improved.

### CROSS-REFERENCE TO RELATED APPLICATIONS

This application claims priority of Chinese Patent Application No. 202510016960.5, filed on Jan. 6, 2025, the contents of which are hereby incorporated by reference.

### TECHNICAL FIELD

This application relates to the field of fault diagnosis technologies, and in particular to, a wind turbine fault diagnosis method and system based on SVD-SSA-LSTM.

### BACKGROUND

Wind power generation, as an important part of renewable energy, its reliability and maintenance efficiency are crucial for the stability and economy of energy supply. However, a gearbox in a wind turbine, as a key component of a transmission system, is susceptible to the impact of harsh operating environments and thus experiences faults.

Traditional fault diagnosis methods have problems such as long diagnosis cycles and low accuracy, and cannot meet the needs of modern wind power systems.

### SUMMARY

The objective of this application is to solve the above technical problems by providing a wind turbine fault diagnosis method and system based on SVD-SSA-LSTM, aiming to improve the diagnosis accuracy of wind turbine faults and shorten the diagnosis cycle.

In some embodiments of this application, acquired vibration signals are decomposed by using singular value decomposition (SVD) noise reduction to remove redundant and noise components in the signals, then faults of a wind turbine are diagnosed by using a SSA-LSTM fault diagnosis model, and through the capability of a LSTM network to process time-series data, the accuracy of wind turbine fault diagnosis is improved, while shortening the diagnosis cycle and improving the early warning efficiency for fault risks of the wind turbine.

In some embodiments of this application, by establishing a plurality of monitoring points, a plurality of groups of vibration signals are collected at a single monitoring time node, and mutual correction is performed on all the vibration signals according to a preset calibration model, thereby improving the authenticity of the collected vibration signals and avoiding distortion of the collected vibration signals caused by environmental disturbances which would otherwise affect the fault diagnosis results.

In some embodiments of this application, there is provided a wind turbine fault diagnosis method based on SVD-SSA-LSTM, including:
setting a plurality of monitoring points according to equipment parameters of a wind turbine tower;
acquiring vibration signals of each monitoring point according to preset monitoring time nodes, and generating a fault feature data packet according to all the vibration signals; and
establishing a fault diagnosis model, and generating a fault diagnosis result according to the fault diagnosis model and the fault feature data packet;
where said setting a plurality of monitoring points includes: establishing a monitoring point sequence A, where A=(a1, a2, . . . , ai, . . . , an), ai is an i-th monitoring point, and n is a number of the monitoring points.

In some embodiments of this application, said generating a fault feature data packet according to all the vibration signals includes:
acquiring the vibration signal of each monitoring point at a current monitoring time node;
processing all the vibration signals according to a preset calibration model;
generating primary vibration signals according to a processing result;
decomposing the primary vibration signals according to a preset SVD model, and generating fault time-frequency domain feature information according to a decomposition result; and
generating the fault feature data packet at the current monitoring time node according to the fault time-frequency domain feature information.

In some embodiments of this application, said generating primary vibration signals according to a processing result includes:
generating a vibration curve for each monitoring point according to all the monitoring signals;
generating a standard comparison curve according to a fusion result of the vibration curves;
sequentially generating a deviation evaluation value between each vibration curve and the standard comparison curve;
establishing a deviation evaluation value sequence D, where D=(d1, d2, . . . , di, . . . , dn), and di is the deviation evaluation value between the vibration curve of the i-th monitoring point and the standard comparison curve;
generating a correction evaluation value g;
where

$$g = [ {\sum }_{i = 1}^{n} di ] ;$$

presetting a correction evaluation value threshold G1;
if g<G1, generating a primary processing instruction;
if g>G1, generating a secondary processing instruction; and
generating the primary vibration signals according to the processing instruction.

In some embodiments of this application, said establishing a fault diagnosis model includes:
establishing training set data according to historical vibration data;
establishing an LSTM network, and setting a plurality of groups of parameter configuration strategies for the LSTM network;
establishing a sparrow individual sequence P, where P=(p1, p2 . . . , pi, . . . , pm), a single sparrow represents a group of parameter configuration strategies, pi is an i-th sparrow individual, and m is a number of the parameter configuration strategies;
generating initial fitness of each sparrow individual according to the training set data;
setting a sparrow position iteration strategy according to a preset SSA optimization model;
outputting primary fitness of each sparrow according to the iteration strategy;
establishing a primary fitness sequence B, where B=(b1, b2, . . . , bi, . . . , bm), bi is the primary fitness of the i-th sparrow individual, and m is a number of the sparrow individuals;
setting the sparrow individual corresponding to a maximum value bmax in the primary fitness sequence B as a target sparrow individual; and
generating the fault diagnosis model according to the parameter configuration strategy corresponding to the target sparrow individual and the LSTM network.

In some embodiments of this application, said setting a sparrow position iteration strategy according to a preset SSA optimization model includes:
dividing the sparrows in the sparrow individual sequence J into discoverers, joiners, and sentinels; and
establishing a discoverer iteration model, a joiner iteration model, and a sentinel iteration model;
where the discoverer iteration model is:

$${X}_{i , j}^{t + 1} = \{ \begin{matrix}{X}_{i , j}^{t} \cdot exp ( . \frac{- i}{{α}_{m} \cdot {iter}_{max}} & AL > ST \\ {X}_{i , j}^{t} + {Q}_{m} \cdot {L}_{m} & AL < ST\end{matrix} ;$$

where

$${X}_{i , j}^{t + 1}$$

is a j-th dimension parameter of an i-th sparrow in a t-th iteration, iterₘₐₓ is a maximum number of iterations, aₘ represents a random number between 0 and 1, ST is a safety coefficient, AL is an alarm value, Qₘ is a random number following a normal distribution, and Lₘ is a 1×d-dimensional matrix with all elements being 1.

In some embodiments of this application, the joiner iteration model includes:

$${X}_{i , j}^{t + 1} = \{ \begin{matrix}{Q}_{m} \cdot exp ( \frac{{X}_{worst}^{t} - {X}_{i , j}^{t}}{{l}_{m}^{2}} ) & i > \frac{{N}_{m}}{2} \\ {X}_{p}^{t + 1} + \vert {X}_{i , j}^{t} - {X}_{p}^{t + 1} \vert \cdot {A}^{+} \cdot L & i \leq \frac{{N}_{m}}{2}\end{matrix} ;$$

where Nₘ is a total number of the sparrows, Xₚ is a position of the sparrow with an optimal foraging state, X_{worst} is a position of the sparrow with a worst foraging state, A⁺ satisfies A⁺=A^{T}(AA^{T})−1, and A is a 1×d-dimensional matrix composed of random elements of 1 or −1.

In some embodiments of this application, the sentinel iteration model includes:

$${X}_{i , j}^{t + 1} = \{ \begin{matrix}{X}_{best}^{t} + {β}_{m} \cdot \vert {X}_{i , j}^{t} - {X}_{best}^{t} \vert & {f}_{i} > {f}_{g} \\ {X}_{i , j}^{t} + {K}_{m} \cdot ( \frac{\vert {X}_{i , j}^{t} - {X}_{worst}^{t} \vert}{( {f}_{i} - {f}_{w} ) + {ε}_{m}} ) & {f}_{i} = {f}_{g}\end{matrix} ;$$

where

$${X}_{best}^{t}$$

is a central position of an entire sparrow population in the iteration, which has no threat from natural enemies, βₘ is a compensation control parameter following a standard normal distribution, Kₘ is a random number between −1 and 1, εₘ is an infinitesimal number, fᵢ is fitness of a current sparrow, f_{g} is fitness of the sparrow currently at an optimal foraging position, and f_{w} is fitness of the sparrow currently at a worst foraging position.

In some embodiments of this application, there is provided a wind turbine fault diagnosis system based on SVD-SSA-LSTM, which includes:
a central control unit configured to set a plurality of monitoring points according to equipment parameters of a wind turbine tower; and
a monitoring unit including a plurality of monitoring sub-modules configured to collect vibration signals of each monitoring point; where
the central control unit includes:
a first processing module configured to establish a monitoring point sequence A, where A=(a1, a2, . . . , ai, . . . , an), ai is an i-th monitoring point, and n is a number of the monitoring points;
a second processing module configured to acquire the vibration signals of each monitoring point according to preset monitoring time nodes, and generate a fault feature data packet according to all the vibration signals; and
a third processing module configured to establish a fault diagnosis model, and generate a fault diagnosis result according to the fault diagnosis model and the fault feature data packet.

In some embodiments of this application, the second processing module is further configured to:
acquire the vibration signal of each monitoring point at a current monitoring time node;
process all the vibration signals according to a preset calibration model;
generate primary vibration signals according to a processing result;
decompose the primary vibration signals according to a preset SVD model, and generate fault time-frequency domain feature information according to a decomposition result; and
generate the fault feature data packet at the current monitoring time node according to the fault time-frequency domain feature information.

In some embodiments of this application, the third processing module is further configured to:
establish training set data according to historical vibration data;
establish an LSTM network, and set a plurality of groups of parameter configuration strategies for the LSTM network;
establish a sparrow individual sequence P, where P=(p1, p2 . . . , pi, . . . , pm), a single sparrow represents a group of parameter configuration strategies, pi is an i-th sparrow individual, and m is a number of the parameter configuration strategies;
generate initial fitness of each sparrow individual according to the training set data;
set a sparrow position iteration strategy according to a preset SSA optimization model;
output primary fitness of each sparrow according to the iteration strategy;
establish a primary fitness sequence B, where B=(b1, b2, . . . , bi, . . . , bm), bi is the primary fitness of the i-th sparrow individual, and m is a number of the sparrow individuals;
set the sparrow individual corresponding to a maximum value bmax in the primary fitness sequence B as a target sparrow individual; and
generate the fault diagnosis model according to the parameter configuration strategy corresponding to the target sparrow individual and the LSTM network.

Compared with the prior art, an embodiment of this application, which relates to a wind turbine fault diagnosis method and system based on SVD-SSA-LSTM, has the following beneficial effects:

By using singular value decomposition (SVD) noise reduction to decompose the collected vibration signals, redundant and noise components in the signals are removed, then by using the SSA-LSTM fault diagnosis model to diagnose faults of the wind turbine, and through the capability of the LSTM network to process time-series data, the accuracy of wind turbine fault diagnosis is improved, while the diagnosis cycle is shortened and the early warning efficiency for fault risks of the wind turbine is improved.

By establishing a plurality of monitoring points, a plurality of groups of vibration signals are collected at a single monitoring time node, and mutual correction is performed on all the vibration signals according to the preset calibration model, thereby improving the authenticity of the collected vibration signals, and avoiding distortion of the collected vibration signals caused by environmental disturbances which would otherwise affect the fault diagnosis results.

### BRIEF DESCRIPTION OF THE DRAWINGS

FIG. 1 is a schematic flowchart of a wind turbine fault diagnosis method based on SVD-SSA-LSTM in a preferred embodiment of this application.

### DETAILED DESCRIPTION OF THE EMBODIMENTS

The specific implementations of this application will be described in further detail below in conjunction with the drawings and embodiments. The following embodiments are used to illustrate this application, but should not be used to limit the scope of this application.

In the description of this application, it should be understood that the orientations or positional relationships indicated by the terms “central”, “upper”, “lower”, “front”, “rear”, “left”, “right”, “vertical”, “horizontal”, “top”, “bottom”, “inner”, “outer”, etc. are the orientations or positional relationships based on what is shown in the accompanying drawings, and are merely intended to facilitate describing this application and simplify the description, rather than indicating or implying that a device or element referred to must have a specific orientation, and be constructed and operated in a specific orientation, and therefore cannot be construed as a limitation to this application.

The terms “first” and “second” are used for descriptive purposes only and cannot be understood as indicating or implying relative importance or implicitly indicating the number of indicated technical features. Therefore, the features defined with “first” and “second” may explicitly or implicitly include one or more of the features. In the description of this application, unless otherwise specified, “a plurality of” means two or more.

In the description of this application, it should be noted that the terms “installation”, “coupling”, and “connection” should be understood in a broad sense unless explicitly specified and limited otherwise. For example, they may be a fixed connection, a detachable connection, or an integrated connection; a mechanical connection or an electrical connection; a direct coupling, an indirect coupling through an intermediate medium, or an internal communication of two elements. For those of ordinary skill in the art, the specific meanings of the above terms in this application may be understood in light of the specific circumstances.

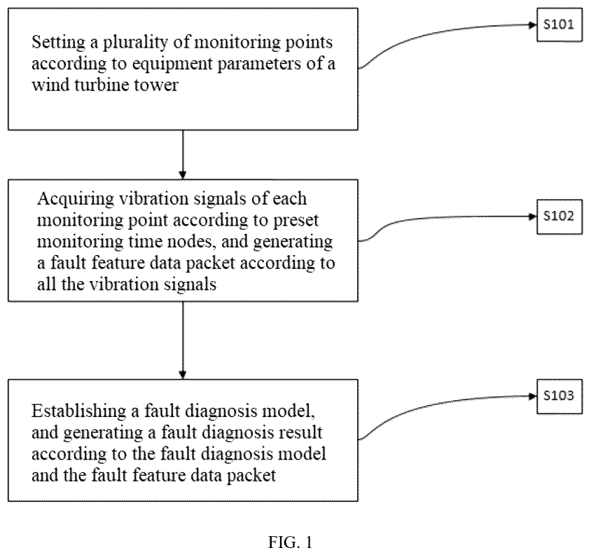

As shown in FIG. 1, in a preferred embodiment of this application, a wind turbine fault diagnosis method based on SVD-SSA-LSTM includes:
setting a plurality of monitoring points according to equipment parameters of a wind turbine tower;
acquiring vibration signals of each monitoring point according to preset monitoring time nodes, and generating a fault feature data packet according to all the vibration signals; and
establishing a fault diagnosis model, and generating a fault diagnosis result according to the fault diagnosis model and the fault feature data packet;
where said setting a plurality of monitoring points includes:
establishing a monitoring point sequence A, where A=(a1, a2, . . . , ai, . . . , an), ai is an i-th monitoring point, and n is a number of the monitoring points.

Specifically, according to the equipment parameters of the wind turbine tower, the plurality of monitoring points are set at the horizontal and vertical positions of the wall of the tower, and vibration sensors are arranged at the respective monitoring points by means of magnetic adsorption.

Specifically, said generating a fault feature data packet according to all the vibration signals includes:
acquiring the vibration signal of each monitoring point at a current monitoring time node;
processing all the vibration signals according to a preset calibration model;
generating primary vibration signals according to a processing result;
decomposing the primary vibration signals according to a preset SVD model, and generating fault time-frequency domain feature information according to a decomposition result; and
generating the fault feature data packet at the current monitoring time node according to the fault time-frequency domain feature information.

Specifically, the fault time-frequency domain feature information includes but is not limited to parameters such as maximum value, minimum value, peak value, variance, standard deviation, root mean square, kurtosis, frequency domain mean value and standard deviation.

Specifically, by constructing a trajectory matrix and performing Singular Value Decomposition (SVD), the trend, periodic components and noise in the vibration signals are extracted to obtain optimized time-series data; further, noise reduction processing is performed on the time-series data, and by selecting an appropriate threshold, redundant and noise components in the signals are removed, and the fault time-frequency domain feature information is retained and extracted.

Specifically, when the SVD model performs singular value decomposition, an adaptive hard threshold selection algorithm and a soft threshold method with unequal optimal weight shrinkage are adopted to improve the adaptability and accuracy of signal processing.

It can be understood that in the above embodiment, the collected vibration signals are decomposed by Singular Value Decomposition (SVD) noise reduction to remove redundant and noise components in the signals, then the SSA-LSTM fault diagnosis model is used to diagnose faults of the wind turbine, and through the capability of the LSTM network to process time-series data, the accuracy of wind turbine fault diagnosis is improved, while the diagnosis cycle is shortened and the early warning efficiency for wind turbine fault risks is improved.

In a preferred embodiment of this application, said generating primary vibration signals according to a processing result includes:
generating a vibration curve for each monitoring point according to all the monitoring signals;
generating a standard comparison curve according to a fusion result of the vibration curves;
sequentially generating a deviation evaluation value between each vibration curve and the standard comparison curve;
establishing a deviation evaluation value sequence D, where D=(d1, d2, . . . , di, . . . , dn), and di is the deviation evaluation value between the vibration curve of the i-th monitoring point and the standard comparison curve;
generating a correction evaluation value g;
where

$$g = [ {\sum }_{i = 1}^{n} di ] ;$$

presetting a correction evaluation value threshold G1;
if g<G1, generating a primary processing instruction;
if g>G1, generating a secondary processing instruction; and
generating the primary vibration signals according to the processing instruction.

Specifically, by comparing each vibration curve, an average curve is generated as the standard comparison curve, a larger deviation evaluation value indicates a lower degree of overlap between a current vibration curve and the standard comparison curve.

Specifically, the correction evaluation value threshold G1 can be set according to historical parameters.

The primary processing instruction means that current vibration signals are not affected by the environment, the vibration signals of the monitoring point with the smallest deviation evaluation value in a horizontal direction and the vibration signals of the monitoring point with the smallest deviation evaluation value in a vertical direction are selected as the primary vibration signals.

Specifically, the secondary processing instruction means that the current vibration signals are disturbed by the environment during collection, the vibration signals of the monitoring points with larger deviation evaluation values need to be eliminated, and judgment is made again based on an elimination result, and corresponding primary vibration signals are generated according to a judgment result.

It can be understood that in the above embodiment, the plurality of monitoring points are established to collect a plurality of groups of vibration signals at a single monitoring time node, and all the vibration signals are mutually corrected according to the preset calibration model, thereby improving the authenticity of the collected vibration signals and avoiding distortion of the collected vibration signals caused by environmental disturbances which would otherwise affect the fault diagnosis result.

In a preferred embodiment of this application, said establishing a fault diagnosis model includes:
establishing training set data according to historical vibration data;
establishing an LSTM network, and setting a plurality of groups of parameter configuration strategies for the LSTM network;
establishing a sparrow individual sequence P, where P=(p1, p2 . . . , pi, . . . , pm), a single sparrow represents a group of parameter configuration strategies, pi is an i-th sparrow individual, and m is a number of the parameter configuration strategies;
generating initial fitness of each sparrow individual according to the training set data;
setting a sparrow position iteration strategy according to a preset SSA optimization model;
outputting primary fitness of each sparrow according to the iteration strategy;
establishing a primary fitness sequence B, where B=(b1, b2, . . . , bi, . . . , bm), bi is the primary fitness of the i-th sparrow individual, and m is a number of the sparrow individuals;
setting the sparrow individual corresponding to a maximum value bmax in the primary fitness sequence B as a target sparrow individual; and
generating the fault diagnosis model according to the parameter configuration strategy corresponding to the target sparrow individual and the LSTM network.

Specifically, the parameter configuration strategy includes parameters such as the number of hidden layer nodes and the learning rate of the LSTM network.

Specifically, the training set data is obtained by simulating or digital twinning fault data.

Specifically, each unit of the LSTM network includes a forget gate, an input gate and an output gate, and through a gating mechanism, further processing of historical information from a previous processing stage is realized.

Specifically, said setting a sparrow position iteration strategy according to a preset SSA optimization model includes:
dividing the sparrows in the sparrow individual sequence J into discoverers, joiners, and sentinels; and
establishing a discoverer iteration model, a joiner iteration model, and a sentinel iteration model;

Specifically, the SSA optimization model is initialized, and relevant parameters of the SSA optimization model, such as population size, maximum number of iterations, and fitness function, are set.

Specifically, the discoverer iteration model is:

$${X}_{i , j}^{t + 1} = \{ \begin{matrix}{X}_{i , j}^{t} \cdot exp ( \frac{- i}{{α}_{m} \cdot {iter}_{max}} & AL > ST \\ {X}_{i , j}^{t} + {Q}_{m} \cdot {L}_{m} & AL < ST\end{matrix} ;$$

where

$${X}_{i , j}^{t + 1}$$

is a j-th dimension parameter of an i-th sparrow in a t-th iteration, iterₘₐₓ is a maximum number of iterations, aₘ represents a random number between 0 and 1, ST is a safety coefficient, AL is an alarm value, Qₘ is a random number following a normal distribution, and Lₘ is a 1×d-dimensional matrix with all elements being 1.

Specifically, the joiner iteration model includes:

$${X}_{i , j}^{t + 1} = \{ \begin{matrix}{Q}_{m} \cdot exp ( \frac{{X}_{worst}^{t} - {X}_{i , j}^{t}}{{l}_{m}^{2}} ) & i > \frac{{N}_{m}}{2} \\ {X}_{p}^{t + 1} + \vert {X}_{i , j}^{t} - {X}_{p}^{t + 1} \vert \cdot {A}^{+} \cdot L & i \leq \frac{{N}_{m}}{2}\end{matrix} ;$$

where Nₘ is a total number of the sparrows, Xₚ is a position of the sparrow with an optimal foraging state, X_{worst} is a position of the sparrow with a worst foraging state, A⁺ satisfies A⁺=A^{T}(AA^{T})−1, and A is a 1×d-dimensional matrix composed of random elements of 1 or −1.

Specifically, the sentinel iteration model includes:

$${X}_{i , j}^{t + 1} = \{ \begin{matrix}{X}_{best}^{t} + {β}_{m} \cdot \vert {X}_{i , j}^{t} - {X}_{best}^{t} \vert & {f}_{i} > {f}_{g} \\ {X}_{i , j}^{t} + {K}_{m} \cdot ( \frac{\vert {X}_{i , j}^{t} - {X}_{worst}^{t} \vert}{( {f}_{i} - {f}_{w} ) + {ε}_{m}} ) & {f}_{i} = {f}_{g}\end{matrix} ;$$

where

$${X}_{best}^{t}$$

is a central position of an entire sparrow population in the iteration, which has no threat from natural enemies, βₘ is a compensation control parameter following a standard normal distribution, Kₘ is a random number between −1 and 1, εₘ is an infinitesimal number, fᵢ is fitness of a current sparrow, f_{g} is fitness of the sparrow currently at an optimal foraging position, and f_{w} is fitness of the sparrow currently at a worst foraging position.

Specifically, for sparrow individuals with higher fitness (producers), their positions are updated according to their current positions, alarm values, safety values and other parameters; for sparrow individuals with lower fitness (searchers), some of them monitor the producers and try to compete with them for food (i.e., update their own positions to approach the optimal positions of the producers), while the other part of them choose to fly to farther areas for random food search, so as to increase the possibility of finding better solutions.

Specifically, during iterative optimization, the process of fitness evaluation and position update is cycled until the maximum number of iterations is reached or other stopping conditions are met. The global optimal solution (i.e., the LSTM network parameter configuration represented by the sparrow individual with the highest fitness) is recorded and updated, and finally the global optimal solution is output as the optimized LSTM network parameter configuration.

Based on another preferred embodiment of the wind turbine fault diagnosis method based on SVD-SSA-LSTM in any of the above preferred embodiments, in this preferred embodiment, there is provided a wind turbine fault diagnosis system based on SVD-SSA-LSTM, including:
a central control unit configured to set a plurality of monitoring points according to equipment parameters of a wind turbine tower; and
a monitoring unit including a plurality of monitoring sub-modules configured to collect vibration signals of each monitoring point; where
the central control unit includes:
a first processing module configured to establish a monitoring point sequence A, where A=(a1, a2, . . . , ai, . . . , an), ai is an i-th monitoring point, and n is a number of the monitoring points;
a second processing module configured to acquire the vibration signals of each monitoring point according to preset monitoring time nodes, and generate a fault feature data packet according to all the vibration signals; and
a third processing module configured to establish a fault diagnosis model, and generate a fault diagnosis result according to the fault diagnosis model and the fault feature data packet.

Specifically, the second processing module is further configured to:
acquire the vibration signal of each monitoring point at a current monitoring time node;
process all the vibration signals according to a preset calibration model;
generate primary vibration signals according to a processing result;
decompose the primary vibration signals according to a preset SVD model, and generate fault time-frequency domain feature information according to a decomposition result; and
generate the fault feature data packet at the current monitoring time node according to the fault time-frequency domain feature information.

Specifically, the third processing module is further configured to:
establish training set data according to historical vibration data;
establish an LSTM network, and set a plurality of groups of parameter configuration strategies for the LSTM network;
establish a sparrow individual sequence P, where P=(p1, p2 . . . , pi, . . . , pm), a single sparrow represents a group of parameter configuration strategies, pi is an i-th sparrow individual, and m is a number of the parameter configuration strategies;
generate initial fitness of each sparrow individual according to the training set data;
set a sparrow position iteration strategy according to a preset SSA optimization model;
output primary fitness of each sparrow according to the iteration strategy;
establish a primary fitness sequence B, where B=(b1, b2, . . . , bi, . . . , bm), bi is the primary fitness of the i-th sparrow individual, and m is a number of the sparrow individuals;
set the sparrow individual corresponding to a maximum value bmax in the primary fitness sequence B as a target sparrow individual; and
generate the fault diagnosis model according to the parameter configuration strategy corresponding to the target sparrow individual and the LSTM network.

According to the first concept of this application, the collected vibration signals are decomposed by Singular Value Decomposition (SVD) noise reduction to remove redundant and noise components in the signals, then the SSA-LSTM fault diagnosis model is used to diagnose faults of the wind turbine, and through the capability of the LSTM network to process time-series data, the accuracy of wind turbine fault diagnosis is improved, while the diagnosis cycle is shortened and the early warning efficiency for wind turbine fault risks is improved.

According to the second concept of this application, the plurality of monitoring points are established to collect a plurality of groups of vibration signals at a single monitoring time node, and all the vibration signals are mutually corrected according to the preset calibration model, thereby improving the authenticity of the collected vibration signals and avoiding distortion of the collected vibration signals caused by environmental disturbances which would otherwise affect the fault diagnosis result.

The above are only the preferred implementations of this application. It should be pointed out that for those of ordinary skill in the art, several improvements and substitutions can be made without departing from the technical principle of this application, and these improvements and substitutions should also be regarded as being in the protection scope of this application.

What is claimed is:

1. A wind turbine fault diagnosis method based on SVD-SSA-LSTM, comprising:
setting a plurality of monitoring points according to equipment parameters of a wind turbine tower;
acquiring vibration signals of each monitoring point according to preset monitoring time nodes, and generating a fault feature data packet according to all the vibration signals; and
establishing a fault diagnosis model, and generating a fault diagnosis result according to the fault diagnosis model and the fault feature data packet; wherein
said setting a plurality of monitoring points comprises:
establishing a monitoring point sequence A, where A=(a1, a2, . . . , ai, . . . , an), ai is an i-th monitoring point, and n is a number of the monitoring points;
said generating a fault feature data packet according to all the vibration signals comprises:
acquiring the vibration signal of each monitoring point at a current monitoring time node;
processing all the vibration signals according to a preset calibration model;
generating primary vibration signals according to a processing result;
decomposing the primary vibration signals according to a preset SVD model, and generating fault time-frequency domain feature information according to a decomposition result; and
generating the fault feature data packet at the current monitoring time node according to the fault time-frequency domain feature information;
said establishing a fault diagnosis model comprises:
establishing training set data according to historical vibration data;
establishing an LSTM network, and setting a plurality of groups of parameter configuration strategies for the LSTM network;
establishing a sparrow individual sequence P, where P=(p1, p2 . . . , pi, . . . , pm), a single sparrow represents a group of parameter configuration strategies, pi is an i-th sparrow individual, and m is a number of the parameter configuration strategies;
generating initial fitness of each sparrow individual according to the training set data;
setting a sparrow position iteration strategy according to a preset SSA optimization model;
outputting primary fitness of each sparrow according to the iteration strategy;
establishing a primary fitness sequence B, where B=(b1, b2, . . . , bi, . . . , bm), bi is the primary fitness of the i-th sparrow individual, and m is a number of the sparrow individuals;
setting the sparrow individual corresponding to a maximum value bmax in the primary fitness sequence B as a target sparrow individual; and
generating the fault diagnosis model according to the parameter configuration strategy corresponding to the target sparrow individual and the LSTM network.

2. The wind turbine fault diagnosis method based on SVD-SSA-LSTM according to claim 1, wherein said generating primary vibration signals according to a processing result comprises:
generating a vibration curve for each monitoring point according to all the monitoring signals;
generating a standard comparison curve according to a fusion result of the vibration curves;
sequentially generating a deviation evaluation value between each vibration curve and the standard comparison curve;
establishing a deviation evaluation value sequence D, where D=(d1, d2, . . . , di, . . . , dn), and di is the deviation evaluation value between the vibration curve of the i-th monitoring point and the standard comparison curve;
generating a correction evaluation value g;
where
$$g = [ {\sum }_{i = 1}^{n} di ] ;$$
presetting a correction evaluation value threshold G1;
if g<G1, generating a primary processing instruction;
if g>G1, generating a secondary processing instruction; and
generating the primary vibration signals according to the processing instruction.

3. The wind turbine fault diagnosis method based on SVD-SSA-LSTM according to claim 2, wherein said setting a sparrow position iteration strategy according to a preset SSA optimization model comprises:
dividing the sparrows in the sparrow individual sequence J into discoverers, joiners, and sentinels; and
establishing a discoverer iteration model, a joiner iteration model, and a sentinel iteration model;
wherein the discoverer iteration model is:
$${X}_{i , j}^{t + 1} = \{ \begin{matrix}{X}_{i , j}^{t} \cdot exp ( \frac{- i}{{α}_{m} \cdot {iter}_{max}} & AL > ST \\ {X}_{i , j}^{t} + {Q}_{m} \cdot {L}_{m} & AL < ST\end{matrix} ;$$
where
$${X}_{i , j}^{t + 1}$$
is a j-th dimension parameter of an i-th sparrow in a t-th iteration, iterₘₐₓ is a maximum number of iterations, aₘ represents a random number between 0 and 1, ST is a safety coefficient, AL is an alarm value, Qₘ is a random number following a normal distribution, and Lₘ is a 1×d-dimensional matrix with all elements being 1.

4. The wind turbine fault diagnosis method based on SVD-SSA-LSTM according to claim 3, wherein the joiner iteration model comprises:
$${X}_{i , j}^{t + 1} = \{ \begin{matrix}{Q}_{m} \cdot exp ( \frac{{X}_{worst}^{t} - {X}_{i , j}^{t}}{{l}_{m}^{2}} ) & i > \frac{{N}_{m}}{2} \\ {X}_{p}^{t + 1} + \vert {X}_{i , j}^{t} - {X}_{p}^{t + 1} \vert \cdot {A}^{+} \cdot L & i \leq \frac{{N}_{m}}{2}\end{matrix} ;$$
where Nₘ is a total number of the sparrows, Xₚ is a position of the sparrow with an optimal foraging state, X_{worst} is a position of the sparrow with a worst foraging state, A⁺ satisfies A⁺=A^{T}(AA^{T})−1, and A is a 1×d-dimensional matrix composed of random elements of 1 or −1.

5. The wind turbine fault diagnosis method based on SVD-SSA-LSTM according to claim 4, wherein the sentinel iteration model comprises:
$${X}_{i , j}^{t + 1} = \{ \begin{matrix}{X}_{best}^{t} + {β}_{m} \cdot \vert {X}_{i , j}^{t} - {X}_{best}^{t} \vert & {f}_{i} > {f}_{g} \\ {X}_{i , j}^{t} + {K}_{m} \cdot ( \frac{\vert {X}_{i , j}^{t} - {X}_{worst}^{t} \vert}{( {f}_{i} - {f}_{w} ) + {ε}_{m}} ) & {f}_{i} = {f}_{g}\end{matrix} ;$$
where
$${X}_{best}^{t}$$
is a central position of an entire sparrow population in the iteration, which has no threat from natural enemies, βₘ is a compensation control parameter following a standard normal distribution, Kₘ is a random number between −1 and 1, εₘ is an infinitesimal number, fᵢ is fitness of a current sparrow, f_{g} is fitness of the sparrow currently at an optimal foraging position, and f_{w} is fitness of the sparrow currently at a worst foraging position.

6. A wind turbine fault diagnosis system based on SVD-SSA-LSTM which adopts the wind turbine fault diagnosis method based on SVD-SSA-LSTM according to claim 1, comprising:
a central control unit configured to set the plurality of monitoring points according to the equipment parameters of the wind turbine tower; and
a monitoring unit comprising a plurality of monitoring sub-modules configured to collect the vibration signals of each monitoring point; wherein
the central control unit comprises:
a first processing module configured to establish the monitoring point sequence A, where A=(a1, a2, . . . , ai, . . . , an), ai is the i-th monitoring point, and n is the number of the monitoring points;
a second processing module configured to acquire the vibration signals of each monitoring point according to the preset monitoring time nodes, and generate the fault feature data packet according to all the vibration signals; and
a third processing module configured to establishing the fault diagnosis model, and generate the fault diagnosis result according to the fault diagnosis model and the fault feature data packet.

7. The wind turbine fault diagnosis system based on SVD-SSA-LSTM according to claim 6, wherein the second processing module is further configured to:
acquire the vibration signal of each monitoring point at the current monitoring time node;
process all the vibration signals according to the preset calibration model;
generate the primary vibration signals according to the processing result;
decompose the primary vibration signals according to the preset SVD model, and generate the fault time-frequency domain feature information according to the decomposition result; and
generate the fault feature data packet at the current monitoring time node according to the fault time-frequency domain feature information.

8. The wind turbine fault diagnosis system based on SVD-SSA-LSTM according to claim 7, wherein the third processing module is further configured to:
establish the training set data according to the historical vibration data;
establish the LSTM network, and set the plurality of groups of parameter configuration strategies for the LSTM network;
establish the sparrow individual sequence P, where P=(p1, p2 . . . , pi, . . . , pm), the single sparrow represents the group of parameter configuration strategies, pi is the i-th sparrow individual, and m is the number of the parameter configuration strategies;
generate the initial fitness of each sparrow individual according to the training set data;
set the sparrow position iteration strategy according to the preset SSA optimization model;
output the primary fitness of each sparrow according to the iteration strategy;
establish the primary fitness sequence B, where B=(b1, b2, . . . , bi, . . . , bm), bi is the primary fitness of the i-th sparrow individual, and m is the number of the sparrow individuals;
set the sparrow individual corresponding to the maximum value bmax in the primary fitness sequence B as the target sparrow individual; and
generate the fault diagnosis model according to the parameter configuration strategy corresponding to the target sparrow individual and the LSTM network.
